(19) United States
(12) Patent Application Publication
(10) Pub. No.: US 2024/0385947 A1
(43) Pub. Date: Nov. 21, 2024

(54) DISPLAYING KEYS AND VALUES IN A MAP AS KEY-VALUE PAIRS IN AN EFFICIENT MANNER

(71) Applicant: International Business Machines Corporation, Armonk, NY (US)

(72) Inventor: Anton Karputkin, Thornhill (CA)

(21) Appl. No.: 18/199,112

(22) Filed: May 18, 2023

(51) Int. Cl. G06F 11/36; G06F 16/22

(52) U.S. Cl. CPC G06F 11/3636; G06F 11/3664; G06F 16/22

(57) ABSTRACT

Described are techniques for displaying a map correctly in a debug environment. A map is traversed to extract the addresses (memory locations) of the keys and values for each key-value pair in the map, where the keys and values of such key-value pairs are located at various memory locations in the map. A structure type with a pair of fields (“key” and “value”) is then created for each key-value pair. Furthermore, a location instance is created that includes 2*K addresses from the extracted addresses of the keys and values for each key-value pair, where K corresponds to the number of extracted key-value pairs. The location instance includes an array of K elements, where each element has the created structure type and corresponds to a key-value pair. The location instance is then passed to a display function to display the array of K elements.

### TECHNICAL FIELD

The present disclosure relates generally to map data structures, and more particularly to displaying the keys and values in a map, such as a hash map, correctly in a debug environment as key-value pairs in an efficient manner even involving debugging tools that support debugging programs written in many different programming languages.

### BACKGROUND

Modern programming languages provide a programming library, which is a collection of prewritten code that programmers can use to optimize tasks. Such programming libraries may include arrays, lists, sets as well as “maps.” A map (also referred to as a “hash map”), such as in the Golang (also referred to as simply “Go”) programming language, is a data structure, which stores a collection of unordered key-value pairs. Keys are the unique identifiers that are associated with a value on a map.

### SUMMARY

In one embodiment of the present disclosure, a computer-implemented method for displaying a map correctly in a debug environment comprises traversing the map extracting addresses of keys and values for each key-value pair. The method further comprises creating a structure type with a pair of fields for each extracted key-value pair. The method additionally comprises creating a location instance that comprises 2*K addresses from the extracted addresses of keys and values for each key-value pair, where the K is a number of the extracted key-value pairs, and where the location instance comprises an array of K elements, where each element of the array of K elements has the created structure type, where each element of the array of K elements corresponds to a key-value pair. Furthermore, the method comprises passing the location instance to a display function to display the array of K elements.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a communication system for practicing the principles of the present disclosure;

FIG. 2 is a diagram of the software components used by the debugging mechanism to display a map correctly in a debug environment even involving debugging tools that support debugging programs written in many different programming languages in accordance with an embodiment of the present disclosure;

FIG. 3 illustrates an embodiment of the present disclosure of the hardware configuration of the debugging mechanism which is representative of a hardware environment for practicing the present disclosure;

FIG. 4 is a flowchart of a method for displaying a map correctly in a debug environment even involving debugging tools that support debugging programs written in many different programming languages in accordance with an embodiment of the present disclosure; and

FIG. 5 is a flowchart of a method for resolving queries to search for specific keys and the associated values in the corresponding key-value pairs in the language of the debug tool in accordance with an embodiment of the present disclosure.

### DETAILED DESCRIPTION

As stated above, modern programming languages provide a programming library, which is a collection of prewritten code that programmers can use to optimize tasks. Such programming libraries may include arrays, lists, sets as well as “maps.” A map (also referred to as a “hash map”), such as in the Golang (also referred to as simply “Go”) programming language, is a data structure, which stores a collection of unordered key-value pairs. Keys are the unique identifiers that are associated with a value on a map.

In certain programming languages, such as Go, the key/value pairs of the map are stored in a list of buckets, where each bucket will hold 8 hashes and 8 key/value pairs (8 keys and 8 values). A hash (a value) is returned by the hash function which is an algorithm that produces an index where a value (associated with the key in the key-value pair) can be found or stored in the map. The hash function takes the key as its input, which is associated with a value in the key-value pair.

From a developer point of view, unless one develops the map itself, many of the fields of the map are not relevant to the developer. Furthermore, usually the developer is only concerned about the keys and values of the map, which may be located at various memory locations. Such keys and values should be presented as key-value pairs as opposed to an array of keys followed by an array of values since such keys are associated with the values in the key-value pairs.

Unfortunately, many debugging tools, such as Java® debugger and C++ debugger, present the keys and values of the map as arrays of keys and arrays of values as opposed to key-value pairs.

Furthermore, while there may be some debugging tools that display a map, such as a map in the Go programming language, as key-value pairs, the debugging tool (e.g., IBM® z/OS® debugger) may aim to support debugging programs written in many different programming languages. However, in order for such debugging tools to correctly display a map (e.g., hash map) in a debug environment, such as displaying the keys and values in the map as key-value pairs, runtimes for each of these programming languages need to be incorporated, which is infeasible.

Hence, there is not currently a means for correctly displaying a map (e.g., hash map) in a debug environment (e.g., VS Code® for the Go programming language), such as displaying the keys and values in the map as key-value pairs, involving debugging tools that support debugging programs written in many different programming languages.

The embodiments of the present disclosure provide a means for correctly displaying a map (e.g., hash map) in a debug environment (e.g., VS Code® for the Go programming language), such as displaying the keys and values in the map as key-value pairs, involving debugging tools that support debugging programs written in many different programming languages as discussed below.

In some embodiments of the present disclosure, the present disclosure comprises a computer-implemented method, system and computer program product for displaying a map correctly in a debug environment. In one embodiment of the present disclosure, a map, such as a map in the Go programming language, is traversed to extract the addresses (memory locations) of the keys and values for each key-value pair in the map, where the keys and values of such key-value pairs are located at various memory locations in the map. In one embodiment, the value associated with a key in the map is retrieved using the syntax m [key]. For example, for the key of “Thursday,” the value (e.g., 4) associated with such a key is retrieved using the syntax m[“Thursday”]. In one embodiment, such keys may include multiple fields. For example, a key may consist of the Vendor_ID and the Location fields as key fields, where the values in each field form a single unique value that is used to match records, such as between two tables. A structure type with a pair of fields (“key” and “value”) is created for each key-value pair. A location instance is then created, such as within the debugged application, that includes 2*K addresses from the extracted addresses of the keys and values for each key-value pair, where K corresponds to the number of extracted key-value pairs. In one embodiment, the location instance is created by utilizing an operator (e.g., DW_OP_PIECE for the DWARF debug format) that merges the extracted addresses into a single virtual location (location instance) representing only the essential part of the map data that is required to be viewed by the software developer. In one embodiment, the location instance includes an array of K elements, where each element of the array of K elements has the created structure type and each element of the array of K elements corresponds to a key-value pair. The location instance is then passed to a display function to display the array of K elements. In this manner, the keys and values in the map may be displayed as key-value pairs even involving debugging tools that support debugging programs written in many different programming languages.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

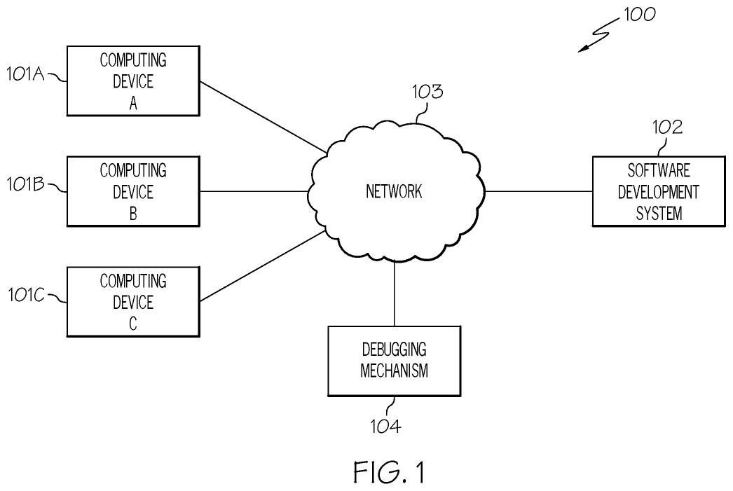

Referring now to the Figures in detail, FIG. 1 illustrates an embodiment of the present disclosure of a communication system 100 for practicing the principles of the present disclosure. Communication system 100 includes computing devices 101A-101C (identified as “Computing Device A,” “Computing Device B,” and “Computing Device C,” respectively, in FIG. 1) connected to a software development system 102 via a network 103. Computing devices 101A-101C may collectively or individually be referred to as computing devices 101 or computing device 101, respectively.

Computing device 101 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 103 and consequently communicating with other computing devices 101 and software development system 102. It is noted that both computing device 101 and the user of computing device 101 may be identified with element number 101.

Software development system 102 is a system utilized, such as by software programmers and software developers (e.g., users of computing devices 101), in the process of creating, designing, deploying and supporting software. Examples of such software development systems, include, but not limited to, RAD Studio®, Embold®, Collaborator®, Studio 3T®, NetBeans®, Zend Studio®, Microsoft® Expression Studio, etc.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

System 100 further includes a debugging mechanism 104 interconnected with computing devices 101 and software development system 102 via network 103. In one embodiment, debugging mechanism 104 is configured to debug a software application, including finding and fixing errors or bugs in the source code of the software application. Furthermore, in one embodiment, debugging mechanism 104 is configured to correctly display a map (e.g., hash map) in the debug environment (e.g., VS Code® for the Go programming language) of debugging mechanism 104, such as correctly displaying the keys and values in the map as key-value pairs even involving debugging tools that support debugging programs written in many different programming languages as discussed further below.

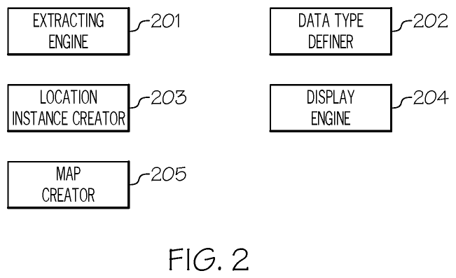

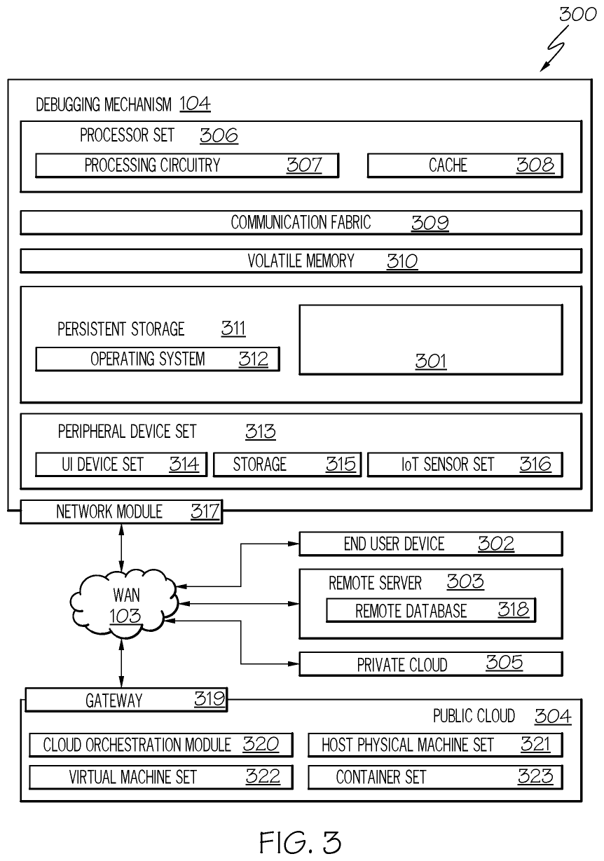

A description of the software components of debugging mechanism 104 used for displaying a map (e.g., hash map in the Go programming language) correctly in a debug environment even involving debugging tools that support debugging programs written in many different programming languages is provided below in connection with FIG. 2. A description of the hardware configuration of debugging mechanism 104 is provided further below in connection with FIG. 3.

System 100 is not to be limited in scope to any one particular network architecture. System 100 may include any number of computing devices 101, software development systems 102, networks 103 and debugging mechanisms 104.

A discussion regarding the software components used by debugging mechanism 104 to display a map (e.g., hash map in the Go programming language) correctly in a debug environment, such as displaying the keys and values in the map as key-value pairs even involving debugging tools that support debugging programs written in many different programming languages, is provided below in connection with FIG. 2.

FIG. 2 is a diagram of the software components used by debugging mechanism 104 (FIG. 1) to display a map (e.g., hash map in the Go programming language) correctly in a debug environment (e.g., VS Code®) of debugging mechanism 104 even involving debugging tools that support debugging programs written in many different programming languages in accordance with an embodiment of the present disclosure.

As shown in FIG. 2, debugging mechanism 104 includes an extracting engine 201 configured to traverse the map (e.g., hash map in the Go programming language) to extract addresses (memory locations) of the keys and values for each key-value pair in the map. As discussed above, a “map,” as used herein, is a data structure which shares a collection of unordered key-value pairs. The keys and values of such key-value pairs are located at various memory locations.

Since the map includes information that may not necessarily be needed to be viewed by the software developer, extracting engine 201 focuses on only extracting the information (e.g., addresses of the keys and values for each key-value pair in the map) that is required to be viewed by the software developer. As previously discussed, such information may be spread across the memory. Such information may be reinterpreted as a location (discussed further below in connection with a location instance) consisting of the extracted addresses of the keys and values.

In one embodiment, extracting engine 201 identifies the key-value pairs by retrieving the value associated with a key in the map using the syntax m [key]. For example, for the key of “Thursday,” the value (e.g., 4) associated with such a key is retrieved using the syntax m[“Thursday”]. In one embodiment, such keys may include multiple fields. For example, a key may consist of the Vendor_ID and the Location fields as key fields, where the values in each field form a single unique value that is used to match records, such as between two tables.

In one embodiment, the keys for such key-value pairs are identified by extracting engine 201 using the containskey( ) method. Upon identifying such keys, the values associated with such keys are identified using the syntax m [key] as discussed above. Such key-value pairs are then stored as elements in an array of a location instance as discussed further below.

Once the keys and values in such key-value pairs are identified, extracting engine 201 traverses the map to extract the addresses of the keys and values for such key-values pairs using various techniques as discussed below.

In one embodiment, extracting engine 201 traverses the map (e.g., hash map in the Go programming language) to extract the addresses of the keys and values for each key-value pair in the map by utilizing a “for” loop using the getValue( ) and getKey( ) functions.

In another embodiment, extracting engine 201 traverses the map (e.g., hash map in the Go programming language) to extract the addresses of the keys and values for each key-value pair in the map by utilizing the “forEach” function to iterate the key-value pairs.

In a further embodiment, extracting engine 201 traverses the map (e.g., hash map in the Go programming language) to extract the addresses of the keys and values for each key-value pair in the map by utilizing an iterator, which is used to iterate each mapped pair in the map.

In another embodiment, extracting engine 201 traverses the map (e.g., hash map in the Go programming language) to extract the addresses of the keys and values for each key-value pair in the map by utilizing lambda expressions. A lambda expression is a short block of code that takes in parameters and returns a value. Lambda expressions are similar to methods, but they do not need a name and can be implemented in the body of a method.

In a further embodiment, extracting engine 201 traverses the map (e.g., hash map in the Go programming language) to extract the addresses of the keys and values for each key-value pair in the map by looping through the map using stream API. Stream API is used to process collections of objects, such as key-value pairs.

In one embodiment, extracting engine 201 implements a lazy load approach when the map includes a very large number of key and value addresses. The “lazy load” approach, as used herein, refers to delaying the load or initialization of resources of objects until they are actually needed in order to improve performance and save system resources. That is, the lazy load approach delays the loading of the key and value addresses until such addresses are actually needed to improve system performance. For example, extracting engine 201 may extract only the first N addresses of the keys and values for each key-value pair, where N is equal to a user-designated number (e.g., 200, 1,000).

Furthermore, debugging mechanism 104 includes a data type definer 202 configured to create a structure type with a pair of fields, key and value, for each extracted key-value pair. A “structure” type, as used herein, is a value type that can encapsulate data and related functionality. In one embodiment, data type definer 202 creates a structure type via a structure declaration, which names a type and specifies a sequence of variable values (“fields” of the structure, such as key and value) that can have different types. For example, the “struct” keyword in the C programming language may be utilized to create a structure type with two fields, key and value.

Additionally, debugging mechanism 104 includes a location instance creator 203 configured to create a location instance that includes 2*K addresses from the extracted addresses of the keys and values (extracted by extracting engine 201) for each key-value pair, where K is the number of the extracted key-value pairs. In one embodiment, such a location instance resides within the debugged application. The debugged application, as used herein, refers to the application being debugged by the debugging tool, such as debugging mechanism 104. A “location instance,” as used herein, refers to a specific realization of a location storing the addresses of the extracted addresses of the keys and values for each key-value pair that were extracted by extracting engine 201. In one embodiment, such addresses are stored in the order of the extracted key-value pairs. For example, the address of the first key is stored followed by storing the address of the first value associated with the first key followed by storing the second key followed by storing the address of the second value associated with the second key and so forth.

In one embodiment, the location instance includes an array of K elements, where each element of the array of K elements has the created structure type (created by data type definer 202) and where each element of the array of K elements corresponds to a key-value pair identified by extracting engine 201.

As previously discussed, the addresses of the keys and values of the map are spread across the memory. Such information may be reinterpreted as a location consisting of the addresses of the keys and values extracted by extracting engine 201. In one embodiment, location instance creator 203 creates the location instance discussed above by utilizing an operator (e.g., DW OP PIECE for the DWARF debug format) that merges the extracted addresses into a single virtual location (location instance) representing only the essential part of the map data that is required to be viewed by the software developer.

In one embodiment, location instance creator 203 passes the created location instance to the display engine 204 of debugging mechanism 104 which corresponds to a display function to display the array of K elements of the location instance, where each element has the created structure type (created by data type definer 202 as previously discussed) and where each element corresponds to a key-value pair of the created location instance. For example, the first element in the array of K elements corresponds to the address of the first key and the address of the first value associated with the first key, the second element in the array of K elements corresponds to the address of the second key and the address of the second value associated with the second key and so forth.

In one embodiment, display engine 204 displays the array of K elements using the “for-each loop” to iterate over the array of K elements.

In another embodiment, display engine 204 displays the array of K elements using standard library arrays, such as the Arrays.toString( ) function.

In one embodiment, extracting engine 201 determines if the total number of elements have been displayed. That is, extracting engine 201 determines if there are more addresses to be loaded due to lazy loading discussed above. If so, extracting engine 201 loads additional addresses of the keys and values for each key-value pair in the map. Otherwise, the display of the map in the debug environment (e.g., VS Code®) of debugging mechanism 104 is complete.

In one embodiment, in order to display the value upon being provided the associated key, debugging mechanism 104 needs to implement the same hash algorithm (produces an index where a value, associated with the key in the key-value pair, can be found or stored in the map) as implemented during the programming language runtime (time that a program is running alongside all the external instructions needed for proper execution). In order to avoid such a requirement, the same traversing algorithm of the present disclosure can be used to search for a specific key as discussed below in connection with map creator 205 of debugging mechanism 104.

In one embodiment, upon receiving a query to search for a specific key, including a key-value pair, in the map, map creator 205 builds a map, such as a hash map, in the language of the debug tool of debugging mechanism 104, where the keys are the binary contents of the original map keys and the values are the addresses of the extracted key-value pairs (key-value pairs extracted by extracting engine 201 as discussed above). “Binary contents,” as used herein, refer to the contents of the keys in the map that were traversed by extracting engine 201 (discussed above) which are in binary format consisting of a series of sequential bytes, each of which is eight bits in length.

In one embodiment, map creator 205 is configured to build a map, such as a hash map, in the language of the debug tool of debugging mechanism 104, where the keys are the binary contents of the original map keys and the values are the addresses of the extracted key-value pairs, using various methods (e.g., put ( ) method) in the HashMap class of Java®. In one embodiment, values in the map (e.g., hash map) may be accessed via the get ( ) method.

In one embodiment, map creator 205 is configured to build the map discussed above using the Java® HashMap class, which implements the map interface which allows a user to store key-value pairs.

In one embodiment, map creator 205 is configured to build the map discussed above by utilizing a dictionary in the C programming language, where the dictionary is used as a collection of key-value pairs. Keys may then be obtained and sorted using the ToList( ) and Sort( ) method, respectively.

Upon building the map, map creator 205 resolves queries to search for elements (specific keys and the associated values in the corresponding key-value pairs) in the built map in the language of the debug tool of debugging mechanism 104. In one embodiment, map creator 205 obtains the requested keys and the associated values in the corresponding key-value pairs from the built map using the get ( ) method. In this manner, elements of the map may be obtained using the map created in the debug tool of debugging mechanism 104 as opposed to traversing the map (e.g., hash map) in the programming language (e.g., Go programming language) the map was originally created.

As a result of the foregoing, a map (e.g., hash map) may be correctly displayed in a debug environment (e.g., VS Code® for the Go programming language), such as displaying the keys and values in the map as key-value pairs even involving debugging tools that support debugging programs written in many different programming languages. Furthermore, as a result of the foregoing, the elements (e.g., key-value pairs) of such a map may even be retrieved in the language of the debug tool.

A further description of these and other features is provided below in connection with the discussion of the method for correctly displaying a map in a debug environment (VS Code® for the Go programming language), such as correctly displaying the keys and values in the map as key-value pairs even involving debugging tools that support debugging programs written in many different programming languages.

Prior to the discussion of the method for correctly displaying a map in a debug environment, a description of the hardware configuration of debugging mechanism 104 (FIG. 1) is provided below in connection with FIG. 3.

Referring now to FIG. 3, in conjunction with FIG. 1, FIG. 3 illustrates an embodiment of the present disclosure of the hardware configuration of debugging mechanism 104 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code (computer code for correctly displaying a map, such as a hash map, in a debug environment is stored in block 301) involved in performing the disclosed methods, such as correctly displaying the keys and values in the map as key-value pairs even involving debugging tools that support debugging programs written in many different programming languages. In addition to block 301, computing environment 300 includes, for example, debugging mechanism 104, network 103, such as a wide area network (WAN), end user device (EUD) 302, remote server 303, public cloud 304, and private cloud 305. In this embodiment, debugging mechanism 104 includes processor set 306 (including processing circuitry 307 and cache 308), communication fabric 309, volatile memory 310, persistent storage 311 (including operating system 312 and block 301, as identified above), peripheral device set 313 (including user interface (UI) device set 314, storage 315, and Internet of Things (IoT) sensor set 316), and network module 317. Remote server 303 includes remote database 318. Public cloud 304 includes gateway 319, cloud orchestration module 320, host physical machine set 321, virtual machine set 322, and container set 323.

Debugging mechanism 104 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 318. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically debugging mechanism 104, to keep the presentation as simple as possible. Debugging mechanism 104 may be located in a cloud, even though it is not shown in a cloud in FIG. 3. On the other hand, debugging mechanism 104 is not required to be in a cloud except to any extent as may be affirmatively indicated.

Processor set 306 includes one, or more, computer processors of any type now known or to be developed in the future. Processing circuitry 307 may be distributed over multiple packages, for example, multiple, coordinated integrated circuit chips. Processing circuitry 307 may implement multiple processor threads and/or multiple processor cores. Cache 308 is memory that is located in the processor chip package(s) and is typically used for data or code that should be available for rapid access by the threads or cores running on processor set 306. Cache memories are typically organized into multiple levels depending upon relative proximity to the processing circuitry. Alternatively, some, or all, of the cache for the processor set may be located “off chip.” In some computing environments, processor set 306 may be designed for working with qubits and performing quantum computing.

Computer readable program instructions are typically loaded onto debugging mechanism 104 to cause a series of operational steps to be performed by processor set 306 of debugging mechanism 104 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 308 and the other storage media discussed below. The program instructions, and associated data, are accessed by processor set 306 to control and direct performance of the disclosed methods. In computing environment 300, at least some of the instructions for performing the disclosed methods may be stored in block 301 in persistent storage 311.

Communication fabric 309 is the signal conduction paths that allow the various components of debugging mechanism 104 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 310 is any type of volatile memory now known or to be developed in the future. Examples include dynamic type random access memory (RAM) or static type RAM. Typically, the volatile memory is characterized by random access, but this is not required unless affirmatively indicated. In debugging mechanism 104, the volatile memory 310 is located in a single package and is internal to debugging mechanism 104, but, alternatively or additionally, the volatile memory may be distributed over multiple packages and/or located externally with respect to debugging mechanism 104.

Persistent Storage 311 is any form of non-volatile storage for computers that is now known or to be developed in the future. The non-volatility of this storage means that the stored data is maintained regardless of whether power is being supplied to debugging mechanism 104 and/or directly to persistent storage 311. Persistent storage 311 may be a read only memory (ROM), but typically at least a portion of the persistent storage allows writing of data, deletion of data and re-writing of data. Some familiar forms of persistent storage include magnetic disks and solid state storage devices. Operating system 312 may take several forms, such as various known proprietary operating systems or open source Portable Operating System Interface type operating systems that employ a kernel. The code included in block 301 typically includes at least some of the computer code involved in performing the disclosed methods.

Peripheral device set 313 includes the set of peripheral devices of debugging mechanism 104. Data communication connections between the peripheral devices and the other components of debugging mechanism 104 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 314 may include components such as a display screen, speaker, microphone, wearable devices (such as goggles and smart watches), keyboard, mouse, printer, touchpad, game controllers, and haptic devices. Storage 315 is external storage, such as an external hard drive, or insertable storage, such as an SD card. Storage 315 may be persistent and/or volatile. In some embodiments, storage 315 may take the form of a quantum computing storage device for storing data in the form of qubits. In embodiments where debugging mechanism 104 is required to have a large amount of storage (for example, where debugging mechanism 104 locally stores and manages a large database) then this storage may be provided by peripheral storage devices designed for storing very large amounts of data, such as a storage area network (SAN) that is shared by multiple, geographically distributed computers. IoT sensor set 316 is made up of sensors that can be used in Internet of Things applications. For example, one sensor may be a thermometer and another sensor may be a motion detector.

Network module 317 is the collection of computer software, hardware, and firmware that allows debugging mechanism 104 to communicate with other computers through WAN 103. Network module 317 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 317 are performed on the same physical hardware device. In other embodiments (for example, embodiments that utilize software-defined networking (SDN)), the control functions and the forwarding functions of network module 317 are performed on physically separate devices, such that the control functions manage several different network hardware devices. Computer readable program instructions for performing the disclosed methods can typically be downloaded to debugging mechanism 104 from an external computer or external storage device through a network adapter card or network interface included in network module 317.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 302 is any computer system that is used and controlled by an end user (for example, a customer of an enterprise that operates debugging mechanism 104), and may take any of the forms discussed above in connection with debugging mechanism 104. EUD 302 typically receives helpful and useful data from the operations of debugging mechanism 104. For example, in a hypothetical case where debugging mechanism 104 is designed to provide a recommendation to an end user, this recommendation would typically be communicated from network module 317 of debugging mechanism 104 through WAN 103 to EUD 302. In this way, EUD 302 can display, or otherwise present, the recommendation to an end user. In some embodiments, EUD 302 may be a client device, such as thin client, heavy client, mainframe computer, desktop computer and so on.

Remote server 303 is any computer system that serves at least some data and/or functionality to debugging mechanism 104. Remote server 303 may be controlled and used by the same entity that operates debugging mechanism 104. Remote server 303 represents the machine(s) that collect and store helpful and useful data for use by other computers, such as debugging mechanism 104. For example, in a hypothetical case where debugging mechanism 104 is designed and programmed to provide a recommendation based on historical data, then this historical data may be provided to debugging mechanism 104 from remote database 318 of remote server 303.

Public cloud 304 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 304 is performed by the computer hardware and/or software of cloud orchestration module 320. The computing resources provided by public cloud 304 are typically implemented by virtual computing environments that run on various computers making up the computers of host physical machine set 321, which is the universe of physical computers in and/or available to public cloud 304. The virtual computing environments (VCEs) typically take the form of virtual machines from virtual machine set 322 and/or containers from container set 323. It is understood that these VCEs may be stored as images and may be transferred among and between the various physical machine hosts, either as images or after instantiation of the VCE. Cloud orchestration module 320 manages the transfer and storage of images, deploys new instantiations of VCEs and manages active instantiations of VCE deployments. Gateway 319 is the collection of computer software, hardware, and firmware that allows public cloud 304 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 305 is similar to public cloud 304, except that the computing resources are only available for use by a single enterprise. While private cloud 305 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 304 and private cloud 305 are both part of a larger hybrid cloud.

Block 301 further includes the software components discussed above in connection with FIG. 2 to correctly display a map in a debug environment. In one embodiment, such components may be implemented in hardware. The functions discussed above performed by such components are not generic computer functions. As a result, debugging mechanism 104 is a particular machine that is the result of implementing specific, non-generic computer functions.

In one embodiment, the functionality of such software components of debugging mechanism 104, including the functionality for correctly displaying a map in a debug environment, may be embodied in an application specific integrated circuit.

As stated above, in certain programming languages, such as Go, the key/value pairs of the map are stored in a list of buckets, where each bucket will hold 8 hashes and 8 key/value pairs (8 keys and 8 values). A hash (a value) is returned by the hash function which is an algorithm that produces an index where a value (associated with the key in the key-value pair) can be found or stored in the map. The hash function takes the key as its input, which is associated with a value in the key-value pair. From a developer point of view, unless one develops the map itself, many of the fields of the map are not relevant to the developer. Furthermore, usually the developer is only concerned about the keys and values of the map, which may be located at various memory locations. Such keys and values should be presented as key-value pairs as opposed to an array of keys followed by an array of values since such keys are associated with the values in the key-value pairs. Unfortunately, many debugging tools, such as Java® debugger and C++ debugger, present the keys and values of the map as arrays of keys and arrays of values as opposed to key-value pairs. Furthermore, while there may be some debugging tools that display a map, such as a map in the Go programming language, as key-value pairs, the debugging tool (e.g., IBM® z/OS® debugger) may aim to support debugging programs written in many different programming languages. However, in order for such debugging tools to correctly display a map (e.g., hash map) in a debug environment, such as displaying the keys and values in the map as key-value pairs, runtimes for each of these programming languages need to be incorporated, which is infeasible. Hence, there is not currently a means for correctly displaying a map (e.g., hash map) in a debug environment (e.g., VS Code® for the Go programming language), such as displaying the keys and values in the map as key-value pairs, involving debugging tools that support debugging programs written in many different programming languages.

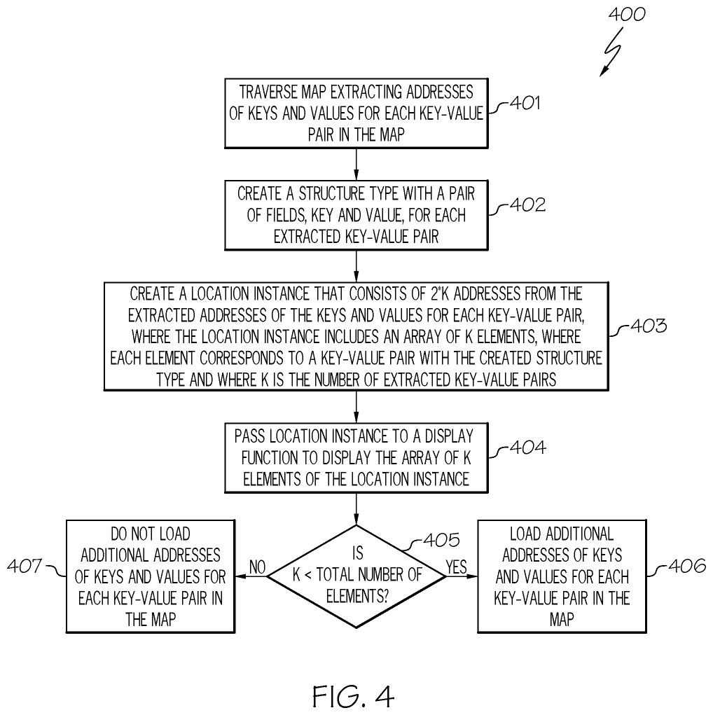

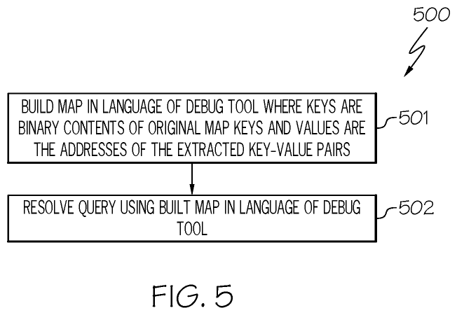

The embodiments of the present disclosure provide a means for correctly displaying a map (e.g., hash map) in a debug environment (e.g., VS Code® for the Go programming language), such as displaying the keys and values in the map as key-value pairs, involving debugging tools that support debugging programs written in many different programming languages as discussed below in connection with FIGS. 4-5. FIG. 4 is a flowchart of a method for displaying a map correctly in a debug environment even involving debugging tools that support debugging programs written in many different programming languages. FIG. 5 is a flowchart of a method for resolving queries to search for specific keys and the associated values in the corresponding key-value pairs in the language of the debug tool.

As stated above, FIG. 4 is a flowchart of a method 400 for displaying a map correctly in a debug environment even involving debugging tools that support debugging programs written in many different programming languages in accordance with an embodiment of the present disclosure.

Referring to FIG. 4, in conjunction with FIGS. 1-3, in operation 401, extracting engine 201 of debugging mechanism 104 traverses the map (e.g., hash map in the Go programming language) to extract addresses of the keys and values for each key-value pair in the map.

As discussed above, a “map,” as used herein, is a data structure which shares a collection of unordered key-value pairs. The keys and values of such key-value pairs are located at various memory locations.

Since the map includes information that may not necessarily be needed to be viewed by the software developer, extracting engine 201 focuses on only extracting the information (e.g., addresses of the keys and values for each key-value pair in the map) that is required to be viewed by the software developer. As previously discussed, such information may be spread across the memory. Such information may be reinterpreted as a location (discussed further below in connection with a location instance) consisting of the extracted addresses of the keys and values.

In one embodiment, extracting engine 201 identifies the key-value pairs by retrieving the value associated with a key in the map using the syntax m[key]. For example, for the key of “Thursday,” the value (e.g., 4) associated with such a key is retrieved using the syntax m[“Thursday”]. In one embodiment, such keys may include multiple fields. For example, a key may consist of the Vendor_ID and the Location fields as key fields, where the values in each field form a single unique value that is used to match records, such as between two tables.

In one embodiment, the keys for such key-value pairs are identified by extracting engine 201 using the containskey ( ) method. Upon identifying such keys, the values associated with such keys are identified using the syntax m [key] as discussed above. Such key-value pairs are then stored as elements in an array of a location instance.

Once the keys and values in such key-value pairs are identified, extracting engine 201 traverses the map to extract the addresses of the keys and values for such key-values pairs using various techniques as discussed below.

In one embodiment, extracting engine 201 traverses the map (e.g., hash map in the Go programming language) to extract the addresses of the keys and values for each key-value pair in the map by utilizing a “for” loop using the getValue ( ) and getKey ( ) functions.

In another embodiment, extracting engine 201 traverses the map (e.g., hash map in the Go programming language) to extract the addresses of the keys and values for each key-value pair in the map by utilizing the “forEach” function to iterate the key-value pairs.

In a further embodiment, extracting engine 201 traverses the map (e.g., hash map in the Go programming language) to extract the addresses of the keys and values for each key-value pair in the map by utilizing an iterator, which is used to iterate each mapped pair in the map.

In another embodiment, extracting engine 201 traverses the map (e.g., hash map in the Go programming language) to extract the addresses of the keys and values for each key-value pair in the map by utilizing lambda expressions. A lambda expression is a short block of code that takes in parameters and returns a value. Lambda expressions are similar to methods, but they do not need a name and can be implemented in the body of a method.

In a further embodiment, extracting engine 201 traverses the map (e.g., hash map in the Go programming language) to extract the addresses of the keys and values for each key-value pair in the map by looping through the map using stream API. Stream API is used to process collections of objects, such as key-value pairs.

In one embodiment, extracting engine 201 implements a lazy load approach when the map includes a very large number of key and value addresses. The “lazy load” approach, as used herein, refers to delaying the load or initialization of resources of objects until they are actually needed in order to improve performance and save system resources. That is, the lazy load approach delays the loading of the key and value addresses until such addresses are actually needed to improve system performance. For example, extracting engine 201 may extract only the first N addresses of the keys and values for each key-value pair, where N is equal to a user-designated number (e.g., 200, 1,000).

In operation 402, data type definer 202 of debugging mechanism 104 creates a structure type with a pair of fields, key and value, for each extracted key-value pair.

As stated above, a “structure” type, as used herein, is a value type that can encapsulate data and related functionality. In one embodiment, data type definer 202 creates a structure type via a structure declaration, which names a type and specifies a sequence of variable values (“fields” of the structure, such as key and value) that can have different types. For example, the “struct” keyword in the C programming language may be utilized to create a structure type with two fields, key and value.

In operation 403, location instance creator 203 of debugging mechanism 104 creates a location instance that includes 2*K addresses from the extracted addresses of the keys and values (extracted by extracting engine 201) for each key-value pair, where K is the number of the extracted key-value pairs.

As discussed above, in one embodiment, such a location instance resides within the debugged application. The debugged application, as used herein, refers to the application being debugged by the debugging tool, such as debugging mechanism 104. A “location instance,” as used herein, refers to a specific realization of a location storing the addresses of the extracted addresses of the keys and values for each key-value pair that were extracted by extracting engine 201. In one embodiment, such addresses are stored in the order of the extracted key-value pairs. For example, the address of the first key is stored followed by storing the address of the first value associated with the first key followed by storing the second key followed by storing the address of the second value associated with the second key and so forth.

In one embodiment, the location instance includes an array of K elements, where each element of the array of K elements has the created structure type (created by data type definer 202) and where each element of the array of K elements corresponds to a key-value pair identified by extracting engine 201.

As previously discussed, the addresses of the keys and values of the map are spread across the memory. Such information may be reinterpreted as a location consisting of the addresses of the keys and values extracted by extracting engine 201. In one embodiment, location instance creator 203 creates the location instance discussed above by utilizing an operator (e.g., DW OP PIECE for the DWARF debug format) that merges the extracted addresses into a single virtual location (location instance) representing only the essential part of the map data that is required to be viewed by the software developer.

In operation 404, location instance creator 203 of debugging mechanism 104 passes the created location instance to display engine 204 of debugging mechanism 104 which corresponds to a display function to display the array of K elements of the location instance, where each element of the array of K elements has the created structure type (created by data type definer 202 as previously discussed) and where each element corresponds to a key-value pair of the created location instance. For example, the first element in the array of K elements corresponds to the address of the first key and the address of the first value associated with the first key, the second element in the array of K elements corresponds to the address of the second key and the address of the second value associated with the second key and so forth.

As stated above, in one embodiment, display engine 204 displays the array of K elements using the “for-each loop” to iterate over the array of K elements.

In another embodiment, display engine 204 displays the array of K elements using standard library arrays, such as the Arrays.toString ( ) function.

In operation 405, extracting engine 201 of debugging mechanism 104 determines if the total number of elements have been displayed. That is, extracting engine 201 determines if there are more addresses to be loaded due to lazy loading discussed above. In other words, extracting engine 201 determines if K is less than the total number of elements (total number of key-value pairs).

If K is less than the total number of elements, then, in operation 406, extracting engine 201 of debugging mechanism 104 loads additional addresses of keys and values for each key-value pair in the map, which are then extracted by extracting engine 201 of debugging mechanism 104 in operation 401 as discussed above.

If, however, K is not less than the total number of elements, then, in operation 407, extracting engine 201 of debugging mechanism 104 does not load additional addresses of keys and values since the display of the map in the debug environment (e.g., VS Code®) of debugging mechanism 104 is complete.

In one embodiment, in order to display the value upon being provided the associated key, debugging mechanism 104 needs to implement the same hash algorithm (produces an index where a value, associated with the key in the key-value pair, can be found or stored in the map) as implemented during the programming language runtime (time that a program is running alongside all the external instructions needed for proper execution). In order to avoid such a requirement, the same traversing algorithm as discussed herein can be used to search for a specific key as discussed below in connection with FIG. 5.

FIG. 5 is a flowchart of a method 500 for resolving queries to search for specific keys and the associated values in the corresponding key-value pairs in the language of the debug tool in accordance with an embodiment of the present disclosure.

Referring to FIG. 5, in conjunction with FIGS. 1-4, in operation 501, upon traversing the map for the first time, such as for exacting the addresses of the keys and values for each key-value pair by extracting engine 201 as discussed above, map creator 205 of debugging mechanism 104 builds a map, such as a hash map, in the language of the debug tool of debugging mechanism 104, where the keys are the binary contents of the original map keys and the values are the addresses of the extracted key-value pairs (key-value pairs extracted by extracting engine 201 as discussed above).

As discussed above, “binary contents,” as used herein, refer to the contents of the keys in the map that were traversed by extracting engine 201 (discussed above) which are in binary format consisting of a series of sequential bytes, each of which is eight bits in length.

In one embodiment, map creator 205 is configured to build a map, such as a hash map, in the language of the debug tool of debugging mechanism 104, where the keys are the binary contents of the original map keys and the values are the addresses of the extracted key-value pairs, using various methods (e.g., put ( ) method) in the HashMap class of Java®. In one embodiment, values in the map (e.g., hash map) may be accessed via the get ( ) method.

In one embodiment, map creator 205 is configured to build the map discussed above using the Java® HashMap class, which implements the map interface which allows a user to store key-value pairs.

In one embodiment, map creator 205 is configured to build the map discussed above by utilizing a dictionary in the C programming language, where the dictionary is used as a collection of key-value pairs. Keys may then be obtained and sorted using the ToList ( ) and Sort ( ) method, respectively.

Upon building the map, in operation 502, map creator 205 of debugging mechanism 104 resolves queries to search for elements (specific keys and the associated values in the corresponding key-value pairs) in the built map in the language of the debug tool of debugging mechanism 104.

As stated above, in one embodiment, map creator 205 obtains the requested keys and the associated values in the corresponding key-value pairs from the built map using the get ( ) method. In this manner, elements of the map may be obtained using the map created in the debug tool of debugging mechanism 104 as opposed to traversing the map (e.g., hash map) in the programming language (e.g., Go programming language) the map was originally created.

As a result of the foregoing, a map (e.g., hash map) may be correctly displayed in a debug environment (e.g., VS Code® for the Go programming language), such as displaying the keys and values in the map as key-value pairs even involving debugging tools that support debugging programs written in many different programming languages. Furthermore, as a result of the foregoing, the elements (e.g., key-value pairs) of such a map may even be retrieved in the language of the debug tool.

Furthermore, the principles of the present disclosure improve the technology or technical field involving map data structures. As discussed above, in certain programming languages, such as Go, the key/value pairs of the map are stored in a list of buckets, where each bucket will hold 8 hashes and 8 key/value pairs (8 keys and 8 values). A hash (a value) is returned by the hash function which is an algorithm that produces an index where a value (associated with the key in the key-value pair) can be found or stored in the map. The hash function takes the key as its input, which is associated with a value in the key-value pair. From a developer point of view, unless one develops the map itself, many of the fields of the map are not relevant to the developer. Furthermore, usually the developer is only concerned about the keys and values of the map, which may be located at various memory locations. Such keys and values should be presented as key-value pairs as opposed to an array of keys followed by an array of values since such keys are associated with the values in the key-value pairs. Unfortunately, many debugging tools, such as Java® debugger and C++ debugger, present the keys and values of the map as arrays of keys and arrays of values as opposed to key-value pairs. Furthermore, while there may be some debugging tools that display a map, such as a map in the Go programming language, as key-value pairs, the debugging tool (e.g., IBM® z/OS® debugger) may aim to support debugging programs written in many different programming languages. However, in order for such debugging tools to correctly display a map (e.g., hash map) in a debug environment, such as displaying the keys and values in the map as key-value pairs, runtimes for each of these programming languages need to be incorporated, which is infeasible. Hence, there is not currently a means for correctly displaying a map (e.g., hash map) in a debug environment (e.g., VS Code® for the Go programming language), such as displaying the keys and values in the map as key-value pairs, involving debugging tools that support debugging programs written in many different programming languages.

Embodiments of the present disclosure improve such technology by traversing a map, such as a map in the Go programming language, to extract the addresses (memory locations) of the keys and values for each key-value pair in the map, where the keys and values of such key-value pairs are located at various memory locations in the map. In one embodiment, the value associated with a key in the map is retrieved using the syntax m [key]. For example, for the key of “Thursday,” the value (e.g., 4) associated with such a key is retrieved using the syntax m[“Thursday”]. In one embodiment, such keys may include multiple fields. For example, a key may consist of the Vendor_ID and the Location fields as key fields, where the values in each field form a single unique value that is used to match records, such as between two tables. A structure type with a pair of fields (“key” and “value”) is created for each key-value pair. A location instance is then created, such as within the debugged application, that includes 2*K addresses from the extracted addresses of the keys and values for each key-value pair, where K corresponds to the number of extracted key-value pairs. In one embodiment, the location instance is created by utilizing an operator (e.g., DW_OP_PIECE for the DWARF debug format) that merges the extracted addresses into a single virtual location (location instance) representing only the essential part of the map data that is required to be viewed by the software developer. In one embodiment, the location instance includes an array of K elements, where each element of the array of K elements has the created structure type and each element of the array of K elements corresponds to a key-value pair. The location instance is then passed to a display function to display the array of K elements. In this manner, the keys and values in the map may be displayed as key-value pairs even involving debugging tools that support debugging programs written in many different programming languages. Furthermore, in this manner, there is an improvement in the technical field involving map data structures.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for displaying a map correctly in a debug environment, the method comprising:
traversing the map extracting addresses of keys and values for each key-value pair;
creating a structure type with a pair of fields for each extracted key-value pair;
creating a location instance that comprises 2*K addresses from the extracted addresses of keys and values for each key-value pair, wherein the K is a number of the extracted key-value pairs, wherein the location instance comprises an array of K elements, wherein each element of the array of K elements has the created structure type, wherein each element of the array of K elements corresponds to a key-value pair; and
passing the location instance to a display function to display the array of K elements.

2. The method as recited in claim 1 further comprising:
building the map in a language of a debug tool.

3. The method as recited in claim 2, wherein keys of the built map in the language of the debug tool are binary contents of original map keys.

4. The method as recited in claim 3, wherein values of the built map in the language of the debug tools are addresses of the extracted key-value pairs.

5. The method as recited in claim 1, wherein the addresses of keys and values for each key-value pair are extracted using a lazy load approach.

6. The method as recited in claim 1, wherein the location instance resides within a debugged application.

7. The method as recited in claim 1, wherein the map is a hash map.

8. A computer program product for displaying a map correctly in a debug environment, the computer program product comprising one or more computer readable storage mediums having program code embodied therewith, the program code comprising programming instructions for:
traversing the map extracting addresses of keys and values for each key-value pair;
creating a structure type with a pair of fields for each extracted key-value pair;
creating a location instance that comprises 2*K addresses from the extracted addresses of keys and values for each key-value pair, wherein the K is a number of the extracted key-value pairs, wherein the location instance comprises an array of K elements, wherein each element of the array of K elements has the created structure type, wherein each element of the array of K elements corresponds to a key-value pair; and
passing the location instance to a display function to display the array of K elements.

9. The computer program product as recited in claim 8, wherein the program code further comprises the programming instructions for:
building the map in a language of a debug tool.

10. The computer program product as recited in claim 9, wherein keys of the built map in the language of the debug tool are binary contents of original map keys.

11. The computer program product as recited in claim 10, wherein values of the built map in the language of the debug tools are addresses of the extracted key-value pairs.

12. The computer program product as recited in claim 8, wherein the addresses of keys and values for each key-value pair are extracted using a lazy load approach.

13. The computer program product as recited in claim 8, wherein the location instance resides within a debugged application.

14. The computer program product as recited in claim 8, wherein the map is a hash map.

15. A system, comprising:
a memory for storing a computer program for displaying a map correctly in a debug environment; and
a processor connected to the memory, wherein the processor is configured to execute program instructions of the computer program comprising:
traversing the map extracting addresses of keys and values for each key-value pair;
creating a structure type with a pair of fields for each extracted key-value pair;
creating a location instance that comprises 2*K addresses from the extracted addresses of keys and values for each key-value pair, wherein the K is a number of the extracted key-value pairs, wherein the location instance comprises an array of K elements, wherein each element of the array of K elements has the created structure type, wherein each element of the array of K elements corresponds to a key-value pair; and
passing the location instance to a display function to display the array of K elements.

16. The system as recited in claim 15, wherein the program instructions of the computer program further comprise:
building the map in a language of a debug tool.

17. The system as recited in claim 16, wherein keys of the built map in the language of the debug tool are binary contents of original map keys.

18. The system as recited in claim 17, wherein values of the built map in the language of the debug tools are addresses of the extracted key-value pairs.

19. The system as recited in claim 15, wherein the addresses of keys and values for each key-value pair are extracted using a lazy load approach.

20. The system as recited in claim 15, wherein the location instance resides within a debugged application.
